(19) United States
(12) Patent Application Publication
(10) Pub. No.: US 2020/0073340 A1
(43) Pub. Date: Mar. 5, 2020

(54) TIMEPIECE MOVEMENT AND TIMEPIECE

(71) Applicant: Seiko Instruments Inc., Chiba-shi (JP)

(72) Inventors: Kenji OGASAWARA, Chiba-shi (JP); Ken Sato, Chiba-shi (JP)

(21) Appl. No.: 16/540,574

(22) Filed: Aug. 14, 2019

(30) Foreign Application Priority Data
Aug. 29, 2018 (JP) 2018-160705

(51) Int. Cl. G04R 60/14; G04C 11/00; G04R 60/10; G04C 3/00

(52) U.S. Cl. CPC G04R 60/14; G04C 3/008; G04R 60/10; G04C 11/02

(57) ABSTRACT

Provided are a timepiece movement and a timepiece allowing mounting of a wireless communication device in the timepiece and capable of avoiding generation of restrictions to the design of the timepiece. A movement is arranged on the inner side of a timepiece case having a case back, and drives indicator hands. The movement uses an electric wave from the outside as a power source and is equipped with an RFID tag communicating with an external reader.

### RELATED APPLICATIONS

Priority is claimed on Japanese Patent Application No. 2018-160705, filed on Aug. 29, 2018, the content of which is incorporated herein by reference.

### BACKGROUND OF THE INVENTION

### 1. Field of the Invention

The present disclosure relates to a timepiece movement and a timepiece.

### 2. Description of the Related Art

Conventionally, there exists a timepiece in which a wireless communication device such as an RFID tag is mounted (see, for example, JP-A-2001-6007). JP-A-2001-6007 discloses a wristwatch in which a non-contact data transmission/reception unit is arranged on the outer side of a timepiece main body (timepiece case). The non-contact data transmission/reception unit is capable of performing data communication in a non-contact state between itself and an external transmission/reception unit. In a timepiece of this type, historic information on an operation such as battery replacement or repair, information for checking such historic information, information for authenticity determination, etc., are incorporated into the wireless communication device. The information incorporated in the wireless communication device can be read through wireless communication by using an external reader.

When, however, the wireless communication device is provided on the outer side of the timepiece case, there are cases where there are restrictions to the timepiece design.

### SUMMARY OF THE INVENTION

An embodiment of the present invention provides a timepiece movement and a timepiece allowing the mounting of a wireless communication device in the timepiece and capable of avoiding generation of restrictions to the timepiece design.

A timepiece movement according to an embodiment of the present invention is arranged on the inner side of a timepiece case having a case back and drives indicator hands, the timepiece movement being equipped with a wireless communication device using an electric wave from the outside as a power source and configured to communicate with an external reader.

According to the embodiment of the present invention, it is possible to mount the wireless communication device in a timepiece without mounting the wireless communication device on a member of the timepiece facing the exterior. As a result, it is possible to avoid generation of restrictions to the design of the timepiece in which the timepiece movement is mounted.

In particular, in the case where the information incorporated into the wireless communication device is historic information on an operation such as battery replacement or repair, information for checking such historic information, or information for authenticity determination, the scene where the information is read from the wireless communication device by the external reader takes place when an operation such as battery replacement or repair is performed. That is, the scene where the information is read from the wireless communication device by the external reader takes place at the time of an operation necessitating the removal of the case back of the timepiece case. Thus, the wireless communication device is arranged on the inner side of the timepiece case, whereby even when communication between the reader outside the timepiece case and the wireless communication device is difficult, communication between the reader and the wireless communication device is possible whenever communication is necessary, so that it is possible to suppress deterioration in usability as a timepiece equipped with a wireless communication device.

It is desirable that the above-described timepiece movement should have an external surface facing the case back and that the wireless communication device should be arranged within 10 mm from the external surface.

According to the embodiment of the present invention, by removing the case back and opening the interior of the timepiece case, it is possible to bring the external reader to within 10 mm from the wireless communication device. As a result, it is possible to read information from the wireless communication device without having to extract the timepiece movement from within the timepiece case. Thus, it is possible to achieve an improvement in terms of operational efficiency in an operation such as battery replacement or simple repair.

In the above-described timepiece movement, it is desirable that there should be further provided a main plate supporting at least one of a power source generating power for rotating the indicator hands and a train wheel transmitting power to the indicator hands, and that the wireless communication device should be arranged at a position where it cannot be visually identified from at least one of both sides in a thickness direction of the main plate and an outer side in a planar direction of the main plate orthogonal to the thickness direction.

According to the embodiment of the present invention, it is possible to prevent the wireless communication device from being exposed in two directions of one thickness direction of the main plate and the outer side in the planar direction of the main plate. As a result, the wireless communication device is arranged at a position where it is difficult to easily detach it from the timepiece movement. Thus, it is possible to suppress unauthorized replacement of the wireless communication device.

In the above-described timepiece movement, it is desirable that there should be further provided a main plate supporting at least one of a power source generating power for rotating the indicator hands and a train wheel transmitting power to the indicator hands, and a conductive member mounted to the main plate, that the conductive member should be equipped with a flat plate portion extending along a planar direction orthogonal to a thickness direction of the main plate, and an extending portion extending along the thickness direction from an outer edge of the flat plate portion, and that the wireless communication device should be arranged between the flat plate portion and the extending portion as seen from the outside.

According to the embodiment of the present invention, even when the conductive member interrupting an electric wave is arranged around the wireless communication device, it is possible to secure the portion between the flat plate portion and the extending portion as an electric wave propagation route. Thus, it is possible to reliably read information from the wireless communication device by an external reader.

In the above-described timepiece movement, it is desirable that there should be further provided a main plate supporting at least one of a power source generating power for rotating the indicator hands and a train wheel transmitting power to the indicator hands, and a conductive member mounted to the main plate, that the conductive member should be equipped with a flat plate portion extending along a planar direction orthogonal to a thickness direction of the main plate, and that a through-hole should be formed in the flat plate portion, with the wireless communication device being arranged on the inner side of the through-hole as seen from the outside.

According to the embodiment of the present invention, even when the conductive member interrupting an electric wave is arranged around the wireless communication device, it is possible to secure the through-hole as the electric wave propagation route. Thus, it is possible to reliably read information from the wireless communication device by an external reader.

It is desirable that the above-described timepiece movement should have a recess accommodating the wireless communication device.

According to the embodiment of the present invention, it is possible to suppress detachment of the wireless communication device. Thus, it is possible to achieve an improvement in terms of the quality of the timepiece movement equipped with the wireless communication device. Further, since the wireless communication device is surrounded by an inner surface of the recess, it is difficult to easily extract the wireless communication device. Thus, it is possible to suppress unauthorized replacement of the wireless communication device.

In the above-described timepiece movement, it is desirable that a fit-engagement protrusion to be fit-engaged with the wireless communication device should be formed in the inner surface of the recess.

According to the embodiment of the present invention, it is possible to suppress detachment of the wireless communication device from the recess. Thus, it is possible to further improve the quality of the timepiece movement equipped with the wireless communication device.

In the above-described timepiece movement, it is desirable that a swaged portion regulating detachment of the wireless communication device should be formed at an opening edge of the recess.

According to the embodiment of the present invention, it is possible to suppress detachment of the wireless communication device from the recess. Thus, it is possible to further improve the quality of the timepiece movement equipped with the wireless communication device.

In the above-described timepiece movement, it is desirable that there should be further provided a control unit controlling the power source generating power for rotating the indicator hands, and a board on which the control unit is mounted and on which printed wiring is formed, and that the wireless communication device should be surface-mounted on the board at a position where it overlaps the printed wiring.

According to the embodiment of the present invention, when the wireless communication device is detached from the board, the printed wiring can also be separated from the board. As a result, when the wireless communication device is detached from the board, the printed wiring suffers disconnection, and the timepiece movement ceases to operate normally. Thus, it is possible to suppress unauthorized replacement of the wireless communication device.

The timepiece according to the embodiment of the present invention is equipped with a timepiece case having a case back, and a timepiece movement arranged on the inner side of the timepiece case and driving indicator hands, and the timepiece movement is equipped with a wireless communication device using an electric wave from the outside as a power source and configured to communicate with an external reader.

According to the embodiment of the present invention, it is possible to mount the wireless communication device in the timepiece, and there is provided the timepiece movement capable of avoiding generation of restrictions to the design of the timepiece, so that it is possible to provide the timepiece equipped with the wireless communication device and superior in design property.

According to the embodiment of the present invention, it is possible to provide a timepiece movement and a timepiece allowing mounting of a wireless communication device in the timepiece and capable of avoiding generation of restrictions to the design of the timepiece.

### BRIEF DESCRIPTION OF THE DRAWINGS

FIG. 1 is a sectional view of a timepiece according to a first embodiment;

FIG. 2 is a perspective view, as seen from the front side, of a movement according to the first embodiment;

FIG. 3 is a perspective view, as seen from the front side, of a main plate according to the first embodiment;

FIG. 4 is a plan view, as seen from the back side, of a circuit block according to the first embodiment;

FIG. 5 is a partial sectional view of the movement of the first embodiment;

FIG. 6 is a partial sectional view of a movement according to a first modification of the first embodiment;

FIG. 7 is a partial sectional view of a movement according to a second modification of the first embodiment;

FIG. 8 is a perspective view of a part of a main plate according to a third modification of the first embodiment;

FIG. 9 is a partial sectional view of a movement according to a third modification of the first embodiment;

FIG. 10 is a plan view, as seen from the back side, of a circuit block according to a second embodiment;

FIG. 11 is a diagram illustrating the operation of a movement according to the second embodiment, and is a perspective view of a circuit block according to the second embodiment;

FIG. 12 is a perspective view, as seen from the back side, of a movement according to a third embodiment;

FIG. 13 is a plan view, as seen from the front side, of a movement according to a fourth embodiment; and

FIG. 14 is a perspective view, as seen from the front side, of the movement according to the fourth embodiment.

### DETAILED DESCRIPTION OF THE PREFERRED EMBODIMENTS

In the following, embodiments of the present invention will be described with reference to the drawings. In the following embodiments, the present invention is applied to an analog quartz type electronic timepiece as an example of a timepiece. In the following description, components of the same or a similar function are indicated by the same reference numerals. In some cases, a redundant description of such components is left out.

### First Embodiment

FIG. 1 is a sectional view of a timepiece according to the first embodiment.

As shown in FIG. 1, a timepiece 1 according to the embodiment is equipped with a timepiece case 2, a dial 3, indicator hands 4, and a movement 5 (timepiece movement). The timepiece case 2 is equipped with a cylindrical case main body 10 both ends of which are open, a windshield 14 closing one end opening 11 of the case main body 10, and a case back 16 closing the other end opening 12 of the case main body 10. The timepiece case 2 accommodates the dial 3, the indicator hands 4, and the movement 5. In the following description, the windshield 14 side with respect to the movement 5 is referred to as the back side of the movement. The case back 16 side with respect to the movement 5 is referred to as the front side of the movement.

The dial 3 is formed as a disc. The dial 3 is visually recognizable via the windshield 14.

The indicator hands 4 are arranged between the dial 3 and the windshield 14. The indicator hands 4 are mounted to a rotation shaft 21 of the movement 5.

The movement 5 drives the indicator hands 4. The movement 5 is arranged between the dial 3 and the case back 16. In the state in which the case back 16 of the timepiece case 2 is removed, the movement 5 is exposed to the exterior via the other end opening 12 of the case main body 10.

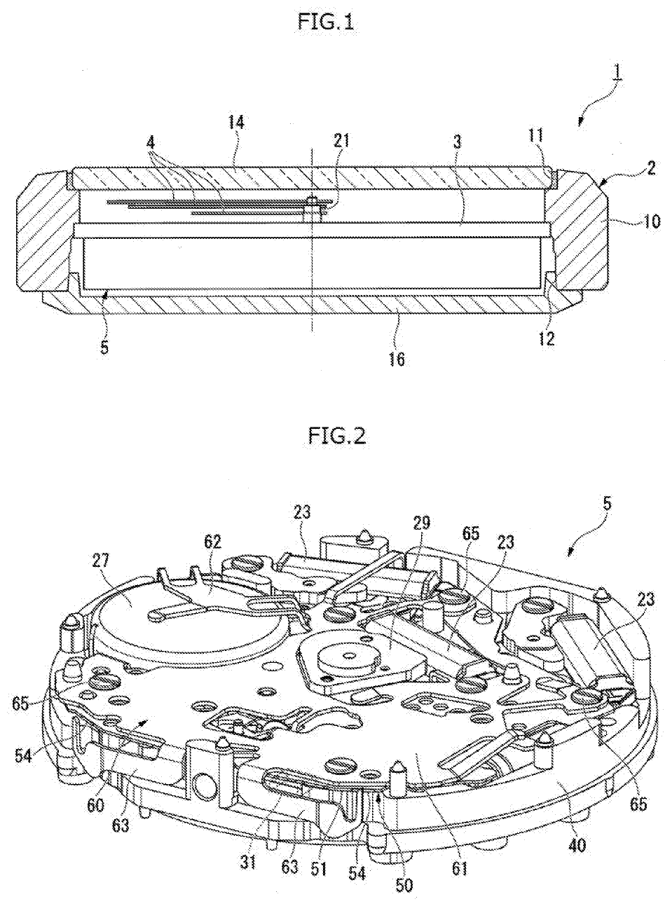

FIG. 2 is a perspective view, as seen from the front side, of the movement of the first embodiment.

As shown in FIG. 2, the movement 5 is equipped with a main plate 40, the rotation shaft 21 (See FIG. 1), a motor 23 (power source), a train wheel (not shown), a battery 27, a train wheel bridge 29, a circuit block 50, a circuit holder 60, and an RFID tag 31 (wireless communication device).

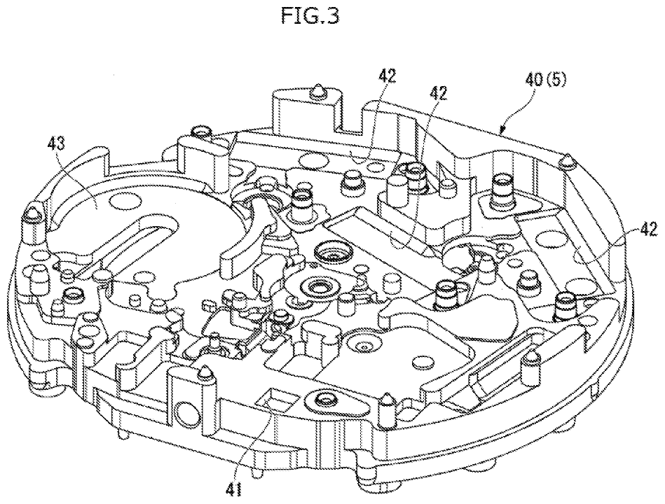

FIG. 3 is a perspective view, as seen from the front side, of the main plate of the first embodiment.

As shown in FIGS. 2 and 3, the main plate 40 constitutes a board of the movement 5. The main plate 40 is formed of an insulating material such as resin material. In correspondence with the configuration of the timepiece case 2 (See FIG. 1), the main plate 40 is formed as a disc in the thickness direction of which coincides with the front-back direction of the movement 5. The main plate 40 supports the motor 23, the train wheel, the battery 27, etc. In the surface of the main plate 40 facing the front side, a recess 41 accommodating the RFID tag 31, a motor retaining portion 42 retaining the motor 23, and a battery retaining portion 43 retaining the battery 27 are formed. The recess 41 will be described in detail below. The motor retaining portion 42 is recessed to the back side so as to allow entrance of the coil of the motor 23. The battery retaining portion 43 is recessed to the back side so as to allow entrance of the battery 27, and is equipped with a side wall surrounding the battery 27 sidewise.

As shown in FIG. 2, the motor 23 is arranged on the front side of the main plate 40. The motor 23 generates the power for rotating the indicator hands 4 (See FIG. 1). The train wheel connects a rotor of the motor 23 to the rotation shaft 21 (See FIG. 1). The train wheel transmits the rotation of the rotor of the motor 23 to the indicator hands 4 mounted to the rotation shaft 21. The train wheel is equipped, for example, with a front train wheel arranged on the front side of the main plate 40. The battery 27 is arranged on the front side of the main plate 40. The battery 27 is the power source of the motor 23.

The train wheel bridge 29 is mounted to the front side of the main plate 40. The train wheel bridge 29 is arranged so as to avoid the battery 27 in plan view. The train wheel bridge 29 rotatably supports the front train wheel between itself and the main plate 40.

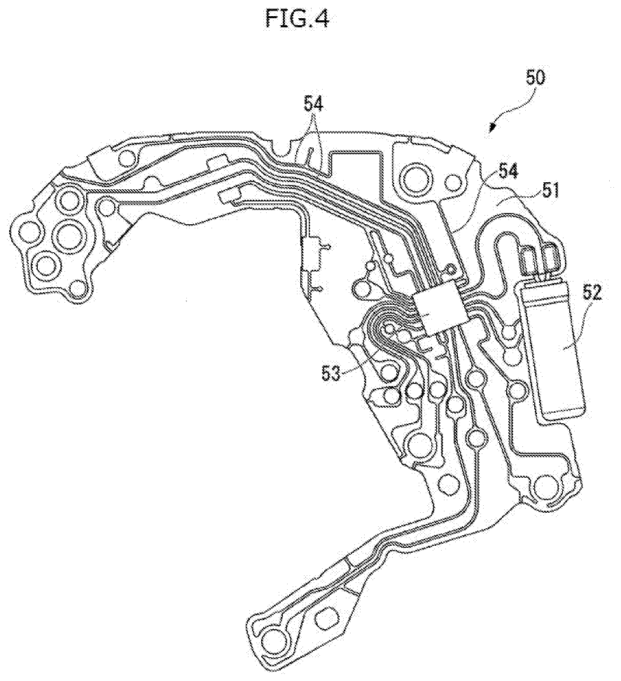

FIG. 4 is a plan view, as seen from the back side, of the circuit block of the first embodiment.

As shown in FIGS. 2 and 4, the circuit block 50 is arranged on the front side of the main plate 40. The circuit block 50 is a printed circuit board. The circuit block 50 is equipped with a board 51 on which printed wiring 54 is formed, and a quartz unit 52 and an integrated circuit 53 (control unit) mounted on the board 51. The integrated circuit 53 controls the motor 23. The integrated circuit 53 is formed by CMOS, PLA or the like. The integrated circuit 53 is operated by the power supplied from the battery 27. The integrated circuit 53 has an oscillating portion (oscillator) outputting a reference signal based on the oscillation of a quartz oscillator of the quartz unit 52, a dividing portion (divider) dividing the reference signal of the oscillating portion, and a driving portion (driver) outputting a motor drive signal (drive pulse) based on the output signal of the dividing portion. The integrated circuit 53 drives the motor 23 by the motor drive signal output from the driving portion.

As shown in FIG. 2, the circuit holder 60 is formed through stamping of a plate member formed of a metal material. The circuit holder 60 is equipped with a flat plate portion 61, a terminal portion 62 extending from the flat plate portion 61, and a switch spring 63 (extending portion). The flat plate portion 61 is arranged so as to hold the circuit block 50 between itself and the main plate 40. The flat plate portion 61 holds the circuit block 50 between itself and the main plate 40. The flat plate portion 61 extends along the planar direction of the main plate 40 orthogonal to the thickness direction of the main plate 40. The flat plate portion 61 is formed so as to avoid the battery 27 in plan view as seen from the thickness direction of the movement 5. The flat plate portion 61 is formed smaller than the main plate 40 in plan view. The flat plate portion 61 is arranged on the inner side of the outer edge of the main plate 40 in plan view. The flat plate portion 61 is fixed to the main plate 40 by a plurality of screws 65.

The terminal portion 62 extends from the portion of the outer edge of the flat plate portion 61 opposite the battery 27. The terminal portion 62 is held in contact with the plus pole of the battery 27 from the front side. Further, the terminal portion 62 extends so as to be astride the battery 27 in plan view, and then extends toward the back side to be locked to the side surface of the main plate 40. As a result, the terminal portion 62 holds the battery 27 between itself and the main plate 40.

The switch spring 63 extends to the back side along the thickness direction of the movement 5 from the outer edge of the flat plate portion 61. The switch spring 63 extends along the side surface of the board 51 of the circuit block 50 and the side surface of the main plate 40. The switch spring 63 is capable of elastic deformation with respect to the flat plate portion 61. The switch spring 63 is provided at a position corresponding to a button (not shown) provided on the timepiece case 2 (See FIG. 1). In the initial state, the switch spring 63 is spaced away from the circuit block 50. When the button is operated, the switch spring 63 is depressed by the button and is deflected to come into contact with the printed wiring 54 on the end surface of the board 51 of the circuit block 50. As a result, a part of the printed wiring 54 attains the same potential as the plus pole of the battery 27, and the integrated circuit 53 of the circuit block 50 detects that the button has been operated.

The circuit holder 60 is further equipped with a contact spring (not shown) electrically continuous with the printed wiring 54 (See FIG. 4) of the board 51. The contact sprig extends from the flat plate portion 61 toward the back side. The contact spring is held in press contact with a part of the printed wiring 54 on the board 51 of the circuit block 50. As a result, the circuit holder 60 makes a part of the printed wiring 54 on the board 51 electrically continuous with the plus pole of the battery 27, supplying electricity to the integrated circuit 53.

FIG. 5 is a sectional view of a part of the movement of the first embodiment.

As shown in FIGS. 2 and 5, the RFID tag 31 is a passive tag operating by using an electric wave from an external reader as the power source. The RFID tag 31 communicates with the external reader. Historic information on an operation such as battery replacement or repair of the movement 5, information for checking such historic information, information for authenticity determination, etc., are incorporated into the RFID tag 31. The information incorporated into the RFID tag 31 can be read by using the external reader. The RFID tag 31 is formed as a rectangular parallelepiped. The RFID 31 is equipped with an RFIC device, an antenna device, and a package accommodating the RFIC device and the antenna device.

As shown in FIGS. 2, 3, and 5, the RFID tag 31 is arranged on the inner side of the recess 41 formed in the main plate 40. As seen from the outside of the movement 5, in the outer peripheral portion of the main plate 40, the recess 41 is formed between the flat plate portion 61 of the circuit holder 60 and the switch spring 63. As a result, as seen from the outside of the movement 5, the RFID tag 31 is arranged between the flat plate portion 61 of the circuit holder 60 and the switch spring 63.

The recess 41 is formed larger than the RFID tag 31 and is formed in a rectangular configuration in plan view. The recess 41 is recessed to the back side and open on the front side. The opening of the recess 41 is closed by the board 51 of the circuit block 50 and the flat plate portion 61 of the circuit holder 60. As a result, the RFID tag 31 is arranged at a position where it cannot be visually recognized from both sides in the thickness direction of the main plate 40 and the outer side in the planar direction of the main plate 40. The RFID tag 31 may be fixed in position in the recess 41 by adhesive, or may be simply placed in the recess 41.

As shown in FIGS. 2 and 5, the RFID tag 31 is arranged within 10 mm from the outer surface of the movement 5 facing the front side. More preferably, the RFID tag 31 is arranged at a position within 10 mm through detour around the circuit holder 60 from the outer surface of the movement 5 facing the front side. At least a part of the RFID tag 31 overlaps the flat plate portion 61 of the circuit holder 60 in plan view. Further, as seen from the outer side in the planar direction of the main plate 40, at least a part of the RFID tag 31 overlaps the switch spring 63 of the circuit holder 60.

As described above, the movement 5 of the present embodiment is equipped with the RFID tag 31 using an electric wave from the outside as the power source and communicating with the external reader. In this structure, it is possible to mount the RFID tag 31 in the timepiece 1 without mounting the RFID tag 31 on a member of the timepiece 1 facing the exterior such as the timepiece case 2 or a strap (not shown). As a result, it is possible to avoid generation of restrictions to the design of the timepiece 1 in which the movement 5 is mounted.

In particular, in the case where the information incorporated into the RFID tag 31 is historic information on an operation such as battery replacement or repair, information for checking such historic information, or information for authenticity determination, the scene where information is read from the RFID tag 31 by the external reader takes place when an operation such as battery replacement or repair of the timepiece 1 is performed. That is, the scene where information is read from the RFID tag 31 by the external reader takes place at the time of an operation requiring the removal of the case back 16 of the timepiece case 2. Thus, the RFID tag 31 is arranged on the inner side of the timepiece case 2, whereby even when communication between the reader outside the timepiece case 2 and the RFID tag 31 is difficult, it is possible to effect communication between the reader and the RFID tag 31 whenever communication is necessary, so that it is possible to suppress deterioration in the usability of the timepiece 1 equipped with the RFID tag 31.

The RFID tag 31 is arranged within 10 mm from the outer surface facing the case back 16 side (the front side of the movement 5). In this structure, by removing the case back 16 and opening the interior of the timepiece case 2, it is possible to bring the external reader to within 10 mm of the RFID tag 31. As a result, it is possible to read information from the RFID tag 31 without having to extract the movement 5 from within the timepiece case 2. Thus, it is possible to achieve an improvement in terms of operational efficiency for battery replacement, simple repair or the like.

Further, the RFID tag 31 is arranged at a position where it cannot be visually recognized from both sides in the thickness direction of the main plate 40 and the outer side in the planar direction of the main plate 40. In this structure, it is possible to prevent the RFID tag 31 from being exposed in two directions of one thickness direction of the main plate 40 and the outer side in the planar direction of the main plate 40. As a result, the RFID tag 31 is arranged at a position where it cannot be easily removed from the movement 5. Thus, it is possible to suppress unauthorized replacement of the RFID tag 31.

The circuit holder 60 formed of metal material is equipped with the flat plate portion 61 extending along the planar direction of the main plate 40, and the switch spring 63 extending along the thickness direction of the main plate 40 from the outer edge of the flat plate portion 61. As seen from the outside, the RFID tag 31 is arranged between the flat plate portion 61 and the switch spring 63. In this structure, even when the circuit holder 60 interrupting an electric wave is arranged around the RFID tag 31, it is possible to secure the portion between the flat plate portion 61 and the switch spring 63 as the propagation route for the electric wave. Thus, it is possible to reliably read information from the RFID tag 31 by the external reader.

The flat plate portion 61 of the circuit holder 60 is arranged on the inner side of the outer edge of the main plate 40 in plan view. As a result, even when the movement 5 is arranged within the timepiece case 2, a gap is formed between the flat plate portion 61 and the inner surface of the timepiece case 2. Thus, it is possible to secure a propagation route for an electric wave between the RFID tag 31 and the external reader. Thus, it is possible to reliably read information from the RFID tag 31 by the external reader without having to extract the movement 5 from the timepiece case 2.

Further, the recess 41 accommodating the RFID tag 31 is formed in the main plate 40. In this structure, it is possible to suppress detachment of the RFID tag 31. Thus, it is possible to improve the quality of the movement 5 equipped with the RFID tag 31. Further, since the RFID tag 31 is surrounded by the inner surface of the recess 41, it is difficult to easily remove the RFID tag 31. Thus, it is possible to suppress unauthorized replacement of the RFID tag 31.

The timepiece 1 of the present embodiment is equipped with the above-described movement 5, so that it is possible to provide the timepiece 1 equipped with the RFID tag 31 and superior in design property.

The method of installing the RFID tag 31 in the recess 41 is not restricted to the method of the first embodiment, and a method according to the following modification may be applied.

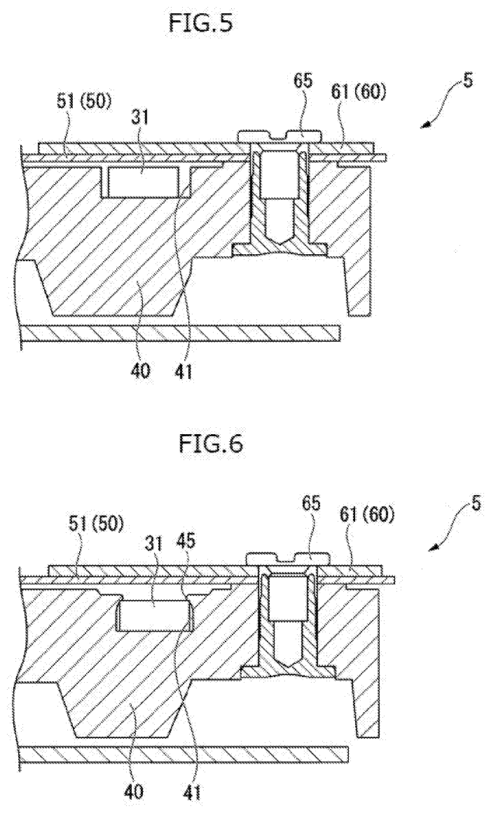

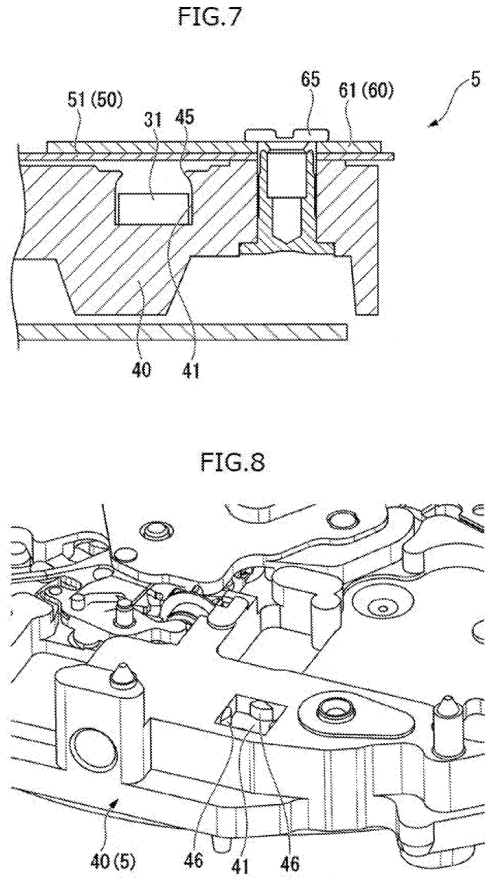

FIG. 6 is a sectional view of a part of a movement according to a first modification of the first embodiment. FIG. 7 is a sectional view of a part of a movement according to a second modification of the first embodiment.

For example, as shown in FIGS. 6 and 7, a swaged portion 45 protruding toward the interior in plan view may be formed at the opening edge of the recess 41 by swaging the opening edge of the recess 41. The swaged portion 45 is formed such that at least a part thereof overlaps the RFID tag 31 in plan view. As a result, the swaged portion 45 regulates detachment of the RFID tag 31 from the recess 41.

As shown in FIG. 6, the recess 41 may be formed such that the swaged portion 45 is constantly in contact with the RFID tag 31 from the front side, or, as shown in FIG. 7, the recess 41 may be formed such that the swaged portion 45 can be spaced away from the RFID tag 31. By forming the swaged portion 45 so as to be capable of being spaced away from the RFID tag 31, it is possible to reduce the force applied to the RFID tag 31 at the time of swaging.

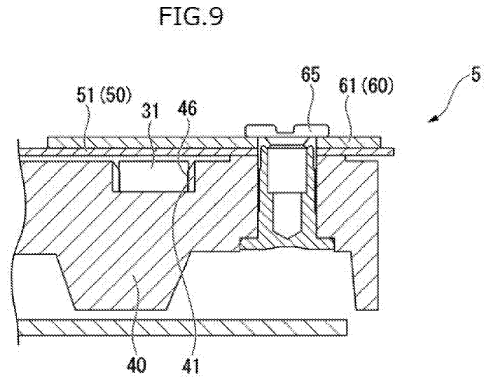

FIG. 8 is a perspective view of a part of the main plate according to a third modification of the first embodiment. FIG. 9 is a sectional view of a part of a movement according to the third modification of the first embodiment.

As shown in FIGS. 8 and 9, on the inner surface of the recess 41, there may be formed a plurality of fit-engagement protrusions 46 to be fit-engaged with the RFID tag 31. In plan view, the plurality of fit-engagement protrusions 46 protrude from four side surfaces of the recess 41 toward the center of the recess 41. In plan view, the fit-engagement protrusions 46 swell in an arcuate fashion, with the tip end portions thereof being in press contact with the side surfaces of the RFID tag 31. As a result, the plurality of fit-engagement protrusions 46 retain the RFID tag 31 on the inner side of the recess 41.

In the structures of these modifications, it is possible to suppress detachment of the RFID tag 31 from the recess 41. Thus, it is possible to further improve the quality of the movement 5 equipped with the RFID tag 31.

### Second Embodiment

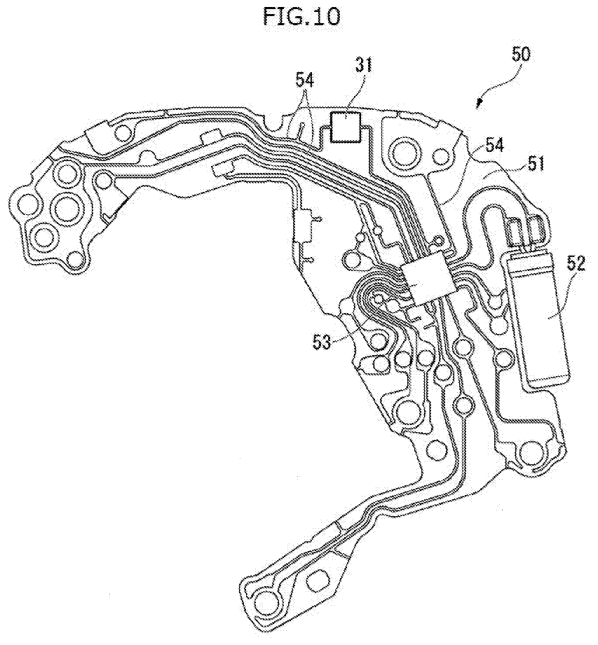

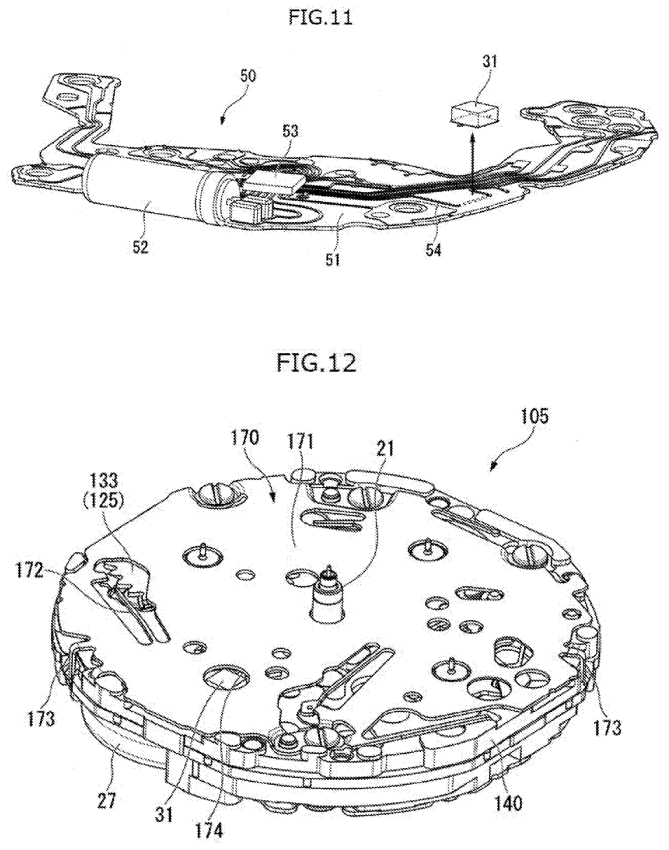

Next, the second embodiment will be described with reference to FIGS. 10 and 11. In the first embodiment, the RFID tag 31 is accommodated on the inner side of the recess 41 of the main plate 40. The second embodiment differs from the first embodiment in that the RFID tag 31 is fixed to the board 51 of the circuit block 50. Apart from what is described below, the structure of the second embodiment is the same as the structure of the first embodiment.

FIG. 10 is a plan view of the circuit block of the second embodiment as seen from the back side.

As shown in FIG. 10, the RFID tag 31 is fixed to the board 51. The RFID tag 31 is surface-mounted on the board 51. The RFID tag 31 is arranged at a position where it overlaps the printed wiring 54. It is desirable for the printed wiring overlapped by the RFID tag 31 to be wiring causing malfunction of the movement 5 when disconnection occurs. For example, the printed wiring is suitably wiring which connects a power line, a switch line, or the motor 23 to the integrated circuit 53.

FIG. 11 is a diagram illustrating the operation of the movement of the second embodiment, and is a perspective view of the circuit block of the second embodiment.

As shown in FIG. 11, when the RFID tag 31 is removed from the board 51, at least a part of the printed wiring 54 is separated from the board 51 along with the RFID tag 31 since the printed wiring 54 and the RFID tag 31 are firmly fixed to each other through surface-mounting. As a result, the printed wiring 54 is disconnected, and the movement 5 undergoes malfunction.

As described above, in the present embodiment, the RFID tag 31 is surface-mounted on the board 51 at a position where it overlaps the printed wiring 54. In this structure, when the RFID tag 31 is removed from the board 51, the printed wiring 54 can also be separated from the board 51. As a result, when the RFID tag 31 is removed from the board 51, the printed wiring 54 undergoes disconnection, and the movement 5 ceases to operate in the normal fashion. Thus, it is possible to suppress unauthorized replacement of the RFID tag 31.

While in the second embodiment the RFID tag 31 is fixed to the board 51 through surface mounting, this should not be construed restrictively. The RFID tag 31 may be fixed to the board 51 by adhesive. From the viewpoint, however, in order to separate the printed wiring 54 from the board 51 along with the RFID tag 31, surface mounting is more suitable since it helps to fix the printed wiring 54 and the RFID tag 31 more firmly to each other.

### Third Embodiment

Next, the third embodiment will be described with reference to FIG. 12. In the first embodiment, the RFID tag 31 is arranged between the flat plate portion 61 of the circuit holder 60 and the switch spring 63 as seen from the outside of the movement 5. The third embodiment differs from the first embodiment in that the RFID tag 31 is arranged on the inner side of a through-hole 174 of a setting lever jumper 170 as seen from the outside of a movement 105. Apart from what is described below, the structure of the third embodiment is the same as the structure of the first embodiment.

FIG. 12 is a perspective view, as seen from the back side, of the movement of the third embodiment.

As shown in FIG. 12, the movement 105 is equipped with a main plate 140, the rotation shaft 21, a train wheel 125, the battery 27, the setting lever jumper 170, and the RFID tag 31. The main plate 140 supports a motor (not shown), the train wheel 125, the battery 27, etc. For example, the train wheel 125 is equipped with a cogwheel 133 arranged on the back side of the main plate 140. The train wheel 125 transmits the rotation of the rotor of the motor to the indicator hands 4 (See FIG. 1).

The setting lever jumper 170 is formed through stamping of a plate member formed of a metal material. The setting lever jumper 170 is equipped with a flat plate portion 171, a jumper 172 extending from the flat plate portion 171, and a lock portion 173. The flat plate portion 171 is arranged on the back side of the main plate 140. The flat plate portion 171 extends along the planar direction of the main plate 140. The flat plate portion 171 rotatably supports the train wheel 125 including the cogwheel 133 between itself and the main plate 140. The through-hole 174 is formed in the flat plate portion 171. The through-hole 174 extends through the flat plate portion 171 in the thickness direction of the main plate 140.

The jumper 172 is a component for regulating the position in the rotational direction of the cogwheel 133. The jumper 172 is a cantilever capable of elastic deformation the distal end portion of which is a free end. The distal end portion of the jumper 172 is provided on the front side of the flat plate portion 171. The distal end portion of the jumper 172 can be engaged with the outer periphery of the cogwheel 133. The distal end portion of the jumper 172 is engaged with the toothed portion in the outer periphery of the cogwheel 133, whereby the rotation of the cogwheel 133 is regulated. The lock portion 173 extends toward the front side from the outer edge of the flat plate portion 171. The lock portion 173 is engaged with the outer peripheral surface of the main plate 140. As a result, the setting lever jumper 170 holds the train wheel 125 including the cogwheel 133 between the flat plate portion 171 and the main plate 140.

The RFID tag 31 is arranged between the main plate 140 and the flat plate portion 171 of the setting lever jumper 170. For example, the RFID tag 31 is fixed to the main plate 140. The RFID tag 31 is arranged on the inner side of the through-hole 174 of the setting lever jumper 170 as seen from the outside of the movement 105. In the present embodiment, at least a part of the RFID tag 31 is arranged on the inner side of the through-hole 174 in plan view. The RFID tag 31 is arranged at a position where it cannot be visually recognized from both the front side and the outer side in the planar direction of the main plate 140. The RFID tag 31 is arranged within 10 mm of the outer surface of the movement 105 facing the front side.

As described above, in the present embodiment, the setting lever jumper 170 formed of metal material is equipped with the flat plate portion 171 extending along the planar direction of the main plate 140. The through-hole 174 is formed in the flat plate portion 171, and the RFID tag 31 is arranged on the inner side of the through-hole 174 as seen from the outside. In this structure, even when the setting lever jumper 170 interrupting an electric wave is arranged around the RFID tag 31, it is possible to secure the through-hole 174 as the propagation route for the electric wave. Thus, it is possible to reliably read information from the RFID tag 31 by the external reader.

Further, the RFID tag 31 is arranged at a position where it cannot be visually recognized from both the front side and the outer side in the planar direction of the main plate 140. In this structure, it is possible to prevent the RFID tag 31 from being exposed in two directions: one thickness direction of the main plate 140 and the outer side in the planar direction of the main plate 140. As a result, the RFID tag 31 is arranged at a position where it is difficult for the RFID tag 31 to be easily removed. Thus, it is possible to suppress unauthorized replacement of the RFID tag 31.

### Fourth Embodiment

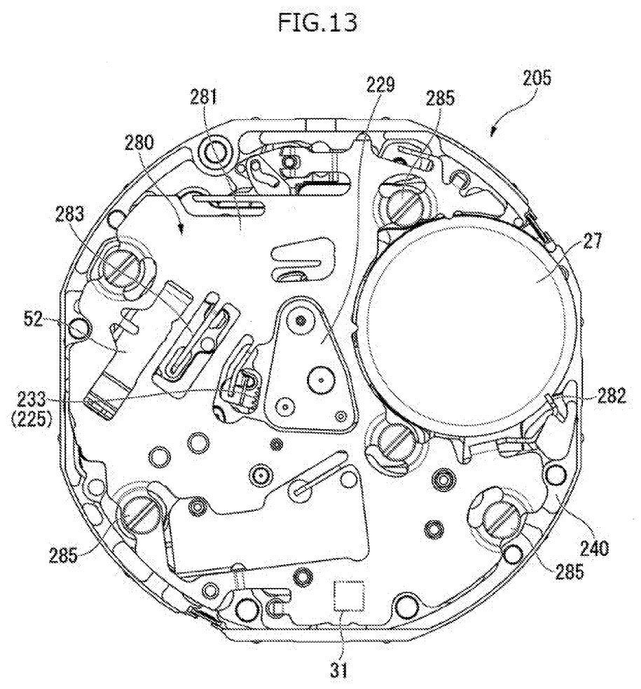

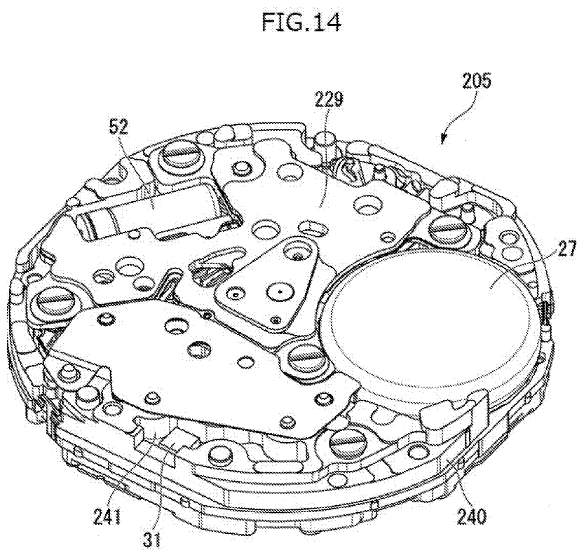

Next, the fourth embodiment will be described with reference to FIGS. 13 and 14. In the first embodiment, at least a part of the RFID tag 31 overlaps the conductive member (the switch spring 63 of the circuit holder 60) as seen from the outer side in the planar direction of the main plate 40. The fourth embodiment differs from the first embodiment in that the RFID tag 31 does not overlap the conductive member (tag block 280) as seen from the outer side in the planar direction of a main plate 240. Apart from what is described below, the structure of the fourth embodiment is the same as the structure of the first embodiment.

FIG. 13 is a plan view, as seen from the front side, of the movement of the fourth embodiment. FIG. 14 is a perspective view, as seen from the front side, of the movement of the fourth embodiment. In the state shown in FIG. 14, the tag block 280 is removed.

As shown in FIGS. 13 and 14, a movement 205 is equipped with the main plate 240, a train wheel 225, the battery 27, a train wheel bridge 229, the quartz unit 52, the tag block 280, and the RFID tag 31. The main plate 240 supports a motor (not shown), the train wheel 225, the battery 27, the quartz unit 52, etc.

As shown in FIG. 14, formed in the main plate 240 is a recess 241 accommodating the RFID tag 31. The recess 241 is formed in the outer peripheral portion of the main plate 240. The recess 241 is recessed to the back side, and is open to the front side. A part of the side surface of the recess 241 is open to the outer side in the planar direction of the main plate 240.

As shown in FIG. 13, the train wheel 225 is equipped with a cogwheel 233 arranged on the front side of the main plate 240. The train wheel 225 transmits the rotation of the rotor of the motor to the indicator hands 4 (See FIG. 1).

As shown in FIGS. 13 and 14, the train wheel bridge 229 is mounted to the front side of the main plate 240. The train wheel bridge 229 is arranged so as to avoid the battery 27 in plan view. The train wheel bridge 229 rotatably supports the train wheel 225 including the cogwheel 233 between itself and the main plate 240.

As shown in FIG. 13, the tag block 280 is formed through stamping of a plate member formed of metal material. The tag block 280 is equipped with a flat plate portion 281, a terminal portion 282 extending from the flat plate portion 281, and a contact spring 283. The flat plate portion 281 is arranged on the front side of the main plate 240. The flat plate portion 281 extends along the planar direction of the main plate 240. The flat plate portion 281 is formed so as to avoid the battery 27 in plan view. The flat plate portion 281 is formed smaller than the main plate 240 in plan view. The flat plate portion 281 is arranged on the inner side of the outer edge of the main plate 240 in plan view. As seen from the front side, the flat plate portion 281 covers the recess 241 (See FIG. 14) of the main plate 240. The flat plate portion 281 is fixed to the main plate 240 by a plurality of screws 285.

The terminal portion 282 extends from the portion of the outer edge of the flat plate portion 281 opposite the battery 27. The terminal portion 282 is in contact with the plus pole of the side surface of the battery 27. The contact spring 283 extends from the flat plate portion 281 toward the back side. The contact spring 283 is in press contact with printed wiring on the circuit board (not shown). As a result, the tag block 280 makes the printed wiring on the circuit board and the plus pole of the battery 27 electrically continuous with each other, supplying electricity to an integrated circuit (not shown) mounted on the circuit board.

As shown in FIGS. 13 and 14, the RFID tag 31 is arranged on the inner side of the recess 241 formed in the main plate 240. The RFID tag 31 is arranged within 10 mm of the outer surface of the movement 205 facing the front side. More preferably, the RFID tag 31 is arranged at a position within 10 mm of the outer surface of the movement 205 facing the front side detouring around the tag block 280. In plan view, the RFID tag 31 overlaps the flat plate portion 281 of the tag block 280. As a result, the RFID tag 31 is arranged at a position where it cannot be visually recognized from both sides in the thickness direction of the main plate 240. Further, as seen from the outer side in the planar direction of the main plate 240, the RFID tag 31 is arranged at a position where it does not overlap the tag block 280. The recess 241 of the main plate 240 may extend through the main plate 240. In this case, it is desirable to fix the RFID tag 31 to the side surface of the recess 241.

As described above, in the present embodiment, the RFID tag 31 is arranged at a position where it cannot be visually recognized from both sides in the thickness direction of the main plate 240. In this structure, it is possible to prevent the RFID tag 31 from being exposed in two directions: one thickness direction of the main plate 240 and the outer side in the planar direction of the main plate 240. As a result, the RFID tag 31 is arranged at a position where it is difficult to easily remove it. Thus, it is possible to suppress unauthorized replacement of the RFID tag 31.

Further, as seen from the outer side in the planar direction of the main plate 240, the RFID tag 31 is arranged at a position where it does not overlap the tag block 280. As a result, it is possible to secure over a wide range the propagation route for an electric wave detouring around the flat plate portion 281 of the tag block 280. Thus, it is possible to reliably read information from the RFID tag 31 by the external reader.

The flat plate portion 281 of the tag block 280 formed of metal material is arranged on the inner side of the outer edge of the main plate 240 in plan view. As a result, even when the movement 205 is arranged in the timepiece case 2, a gap is formed between the flat plate portion 281 interrupting an electric wave and the inner surface of the timepiece case 2. Thus, it is possible to secure a propagation route for an electric wave between the RFID tag 31 and the external reader. Thus, it is possible to reliably read information from the RFID tag 31 by the external reader without having to extract the movement 205 from the timepiece case 2.

The present invention is not restricted to the embodiments described above with reference to the drawings, and various modifications may be possible without departing from the technical scope thereof.

For example, while in the above embodiments the recess accommodating the RFID tag is formed in the main plate, this should not be construed restrictively. The recess may be formed in a member provided separately from the main plate such as a train wheel bridge or a battery frame supporting the battery.

Further, while in the above embodiments the recess formed in the main plate is open in the thickness direction of the main plate, this should not be construed restrictively. The recess may be open on the outer side in the planar direction of the main plate.

Further, while the above embodiments have been described by way of example as applied to a movement mounted in an analog quartz type electronic timepiece and an electronic timepiece, the present invention may also be applied to a movement mounted in a mechanical timepiece.

Apart from this, the components of the above-described embodiments can be replaced by other well-known components as appropriate without departing from the scope of the gist of the present invention. Further, the above-described embodiments and the modifications may be combined with each other as appropriate.

What is claimed is:

1. A timepiece movement arranged in a timepiece having a case back and driving indicator hands, the timepiece movement comprising:
a wireless communication device using an electric wave from the outside as a power source and communicating with an external reader.

2. The timepiece movement according to claim 1, further comprising:
an outer surface facing the case back side,
wherein the wireless communication device is arranged within 10 mm of the outer surface.

3. The timepiece movement according to claim 1, further comprising:
a main plate supporting at least one of a power source generating power for rotating the indicator hands and a train wheel transmitting power to the indicator hands,
wherein the wireless communication device is arranged at a position where it cannot be visually recognized from at least one of both sides in a thickness direction of the main plate and an outer side in a planar direction of the main plate orthogonal to the thickness direction.

4. The timepiece movement according to claim 1, further comprising:
a main plate supporting at least one of a power source generating power for rotating the indicator hands and a train wheel transmitting power to the indicator hands; and
a conductive member mounted to the main plate,
wherein the conductive member includes a flat plate portion extending in a planar direction orthogonal to a thickness direction of the main plate; and
an extending portion extending along the thickness direction from an outer edge of the flat plate portion,
with the wireless communication device being arranged between the flat plate portion and the extending portion as seen from the outside.

5. The timepiece movement according to claim 1, further comprising:
a main plate supporting at least one of a power source generating power for rotating the indicator hands and a train wheel transmitting power to the indicator hands; and
a conductive member mounted to the main plate,
wherein the conductive member includes a flat plate portion extending in a planar direction orthogonal to a thickness direction of the main plate;
a through-hole is formed in the flat plate portion; and
the wireless communication device is arranged on an inner side of the through-hole as seen from the outside.

6. The timepiece movement according to claim 1, further comprising:
a recess accommodating the wireless communication device.

7. The timepiece movement according to claim 6, wherein a fit-engagement protrusion to be fit-engaged with the wireless communication device is formed on an inner surface of the recess.

8. The timepiece movement according to claim 6, wherein a swaged portion regulating detachment of the wireless communication device is formed at an opening edge of the recess.

9. The timepiece movement according to claim 1, further comprising:
a control unit controlling a power source generating power for rotating the indicator hands; and
a board on which the control unit is mounted and on which printed wiring is formed,
wherein the wireless communication device is surface-mounted on the board at a position where it overlaps the printed wiring.

10. A timepiece comprising:
a timepiece case having a case back; and
a timepiece movement arranged on an inner side of the timepiece case and driving indicator hands,
wherein the timepiece movement is equipped with a wireless communication device using an external electric wave as a power source and communicating with an external reader.
